(19) United States
(12) Patent Application Publication
(10) Pub. No.: US 2014/0305041 A1
(43) Pub. Date: Oct. 16, 2014

(54) MODULAR PLANTING SYSTEM

(71) Applicant: Stephen Kincaid MOSS, Strathdicki, Queensland (AU)

(72) Inventor: Stephen Kincaid Moss, Strathdicki (AU)

(21) Appl. No.: 14/357,395

(22) PCT Filed: Nov. 9, 2012
(86) PCT No.: PCT/AU2012/001370

§ 371 Date: May 9, 2014

(30) Foreign Application Priority Data
Nov. 10, 2011 (AU) 2011904675

(51) Int. Cl. A01G 9/02; A01G 1/00

(52) U.S. Cl. CPC A01G 9/02; A01G 1/001
USPC 47/66.7; 47/65.5; 47/79

(57) ABSTRACT

A modular planting system for at least one plant including a support frame having an inner volume within which can be supported at least one root ball of a plant, and an inner support provided within the inner volume for supporting the root ball therein; wherein the root ball is locatable at an optimal position for growth of the plant when the modular planting system is placed within a hole dug to at least substantially accommodate the modular planting system.

### PRIORITY CLAIM

This patent application is a U.S. National Phase of International Patent Application No. PCT/AU2012/001370, filed 9 Nov. 2012, which claims priority to Australian Patent Application No. 2011904675, filed 10 Nov. 2011, the disclosures of which are incorporated herein by reference in their entirety.

### FIELD OF THE INVENTION

The present invention is generally directed to horticultural systems, and in particular to a modular planting system. While the invention is described with respect to its application in the planting of trees, it is to be appreciated that the invention has broader applications and can be used for planting a variety of other plants including palms, orchard trees and plantation plants.

### BACKGROUND OF THE INVENTION

Important horticultural principles for good planting technique include the installation of adequate soil, the removal of air voids by the compacting of the filled soil around the plant roots, ensuring adequate deep water supply, and ensuring that the plant is firmly positioned and not too high or low in the ground.

The traditional approach for planting trees and other plants involves the digging of a suitably sized hole within the planting site to allow room to accommodate the root ball of the plant. The hole must be wide and deep enough to allow room for root growth and to allow the plant to be planted at the appropriate depth. Digging a hole to the correct size for the plant allows for a sufficient amount of friable and nutrient rich soil, fertiliser and other additives to be packed around and below the root ball to support good growth of the plant. The hole must also provide adequate drainage at the base of the hole for the plant. The failure to do these preparatory steps correctly commonly leads to poor plant growth over a long period of time and poor structural stability.

In the common situation where plants are to be planted near underground infrastructure such as water pipes, sewage lines and communication cables, or near a path or roadway, a root guard curtain should preferably be installed about the root ball to protect this infrastructure from future damage due to root incursion by the plant. These root guard curtains are typically installed by lining at least a portion of the planting hole, and should be located at a sufficient distance from the plant to allow for healthy root growth, and sufficient depth to protect services. Incorrect installation of the root guard curtain may result in infrastructure damage and could impact on plant growth.

At least one irrigation pipe should preferably also be laid within the hole prior to filling, the pipe extending from the surface and all the way under the plant to facilitate efficient deep watering of the plant. After the hole is filled, one or more support stakes can be installed to support and stabilize the newly planted plant.

This traditional approach therefore requires the people doing the planting to have at least some horticultural skills to ensure optimal growth of the trees and other plants. Furthermore, it can be very time consuming using this traditional approach where a large number of trees and plants need to be planted at the same time. This can often result in some trees being planted in a sub optimal manner.

### SUMMARY OF THE INVENTION

It is therefore an object of the present invention to overcome one or more of the problems associated with traditional planting methods.

With this in mind, according to one aspect of the present invention, there is provided a modular planting system for at least one plant including:

a support frame having an inner volume within which can be supported at least one root ball of a plant, and an inner support provided within the inner volume for supporting the root ball therein:

wherein the root ball is locatable at an optimal position for growth of the plant when the modular planting system is placed within a hole dug to at least substantially accommodate the modular planting system.

The modular planting system according to the present invention helps to ensure that the root ball of the plant is located at an optimum depth within the hole for the plant type and species, and that an optimum clearance is provided around and below the root ball within the hole to thereby optimise plant growth once the hole is backfilled, and most importantly promote deep root growth. It also promotes a volume of ground or soil disturbance, preferably at least three times the volume of the root ball. This is recognized as good horticultural practice.

The support frame may preferably include a plurality of generally vertically aligned structural supports. The support frame may also include one or more generally horizontally aligned support hoops secured to each structural support. When more than one support hoop is used, the support hoops may be spaced in a generally vertical arrangement one on top of each other. When a single support is used, the support hoop may be secured at or adjacent an upper end of each said structural support. The support loop(s) may be generally circular in shape such that the inner volume defined by the support frame may be generally cylindrical in shape. This facilitates the accommodation of the modular planting system within a cylindrical or other shaped hole dug using a back hoe bucket or machine mounted soil auger. It is however to be appreciated that alternative external shapes for the modular planting system are also envisaged. For example, the planting system may have a square or rectangular cross-section depending on the application.

The structural supports may provide a generally vertically aligned opening that may allow a plant stake to be accommodated therein. Each structural support may for example be in the form of an elongate tube having an internal diameter sufficient to accommodate the plant stake. Alternatively. each structural support may be in the form of a corrugated sheet or channel section having a channel portion and one or two peripheral flange portions on one or either side of the channel portion. When the structural support is secured to a support hoop, there may be sufficient space between the channel portion and support hoop to accommodate therein a plant stake. One or more tags may also extend from the flange portions over the channel portion to help to guide the plant stake through the channel portion. One or more apertures may be provided though the or each flange portion, and corresponding apertures may be provided though the support hoop. Fastening means may be passed through the apertures of the support hoop and the flange portions to enable the structural supports to be secured to the support loop by the fastening means. The fastening means may include plastic or metal rivets, although the use of other fastening means such as a bolt and nut assembly are also envisaged. Each structural support may have a tapered lower end which facilitates the securing and levelling of the modular planting system within the ground. Preferably three said structural supports may be provided for each support frame.

The inner support of the support frame may be supported on and extend between each of the structural supports. The inner support may preferably be in the form of a substantially annular ring having radially extending members for respectively engaging a said structural support. An aperture may be provided within each structural support for accommodating a said radially extending member. The inner support may be supported in a generally horizontal alignment within the support frame when the modular planting system. It is also envisaged that the inner support may be in the form of a support platform to provide a generally horizontally aligned support area for supporting the root ball of a plant thereon at the time of installation. The support platform may for example be formed using a wire grille. It is also envisaged that the inner support be moveable and may therefore be located at different levels within the inner volume.

The support frame may also support an outer mesh wall for providing a root guard curtain for the plant. The outer mesh wall may be in the form of a collapsible mesh such as for example a flexible mesh or a geo grid. The root guard curtain may be supported to extend completely around the outer extent of the support frame and may be positioned at an appropriate height relative to the root ball once the modular planting system has been planted. The root guard may typically be in the form of a dense mesh to restrict root incursion of the plant outside of the constraints of the root guard curtain. Alternatively, or in addition, a lower density screen may be supported about the outer periphery of the support frame. This lower density screen may be located at an uppermost position of the support frame. This screen allows air and water to pass therethrough and can also allow more horizontal root growth of the plant to also pass therethrough.

At least the support hoop of the support frame and preferably the inner support may be made of a biodegradable material such as steel or a biodegradable polymer. The elongated structural supports may however be formed of a non-biodegradable material.

The support frame may further include a secondary side support for retaining the plant at a desired location within the inner volume relative to the outer extent of the support. The plant is preferably located in a central location within the inner volume when only a single plant is being grown, and so the secondary side support may include a central wire loop, with a series of support wires extending radially from the central loop to preferably to one or more of the outer elongated structural supports to secure or pin the root ball. The use of other device or means for securing and pinning the root ball are also envisaged. This arrangement helps to retain the plant in that central position, while the plant is supported from below by the support platform, and also helps to make the retained plant resistant to threat and stabilizes the plant in wind or on steep slopes.

As the plant grows, the secondary side support may be retained in place to support and will eventually become interlaced with the growing root ball of the plant. This arrangement therefore helps to provide extra support and therefore stability to the plant growing within the support frame.

Irrigation arrangements may also be supported within the support frame. For example, at least one or preferably two socked agricultural pipes or other water application devices may be supported within the inner volume of the modular planting system. The agricultural pipe may extend from the top of the support frame to rest preferably adjacent to the inner support at a location underneath the growing plant. Further irrigation pipes may also or alternatively be located in a position around or above the root ball as required. Alternatively, a single agricultural pipe may be used, extending from the top of the support frame, looping under the root ball and back up to the top of the support frame. A circular irrigation pipe may for example be located around the trunk of the plant. These irrigation arrangements will be retained in position within the planting system after planting the modular planting system and will form part of the irrigation system for the plant once planted.

According to another aspect of the present invention, there is provided a method of planting one or more plants using a modular planting system as described above, the method including the steps of digging a hole at a planting site, the hole having a diameter and depth sufficient to at least substantially accommodate the modular planting system, dropping the modular planting system into the hole, placing a root ball of the or each plant within and backfilling the inner volume of the modular planting system.

It may in particular be of advantage to use a back hoe bucket or a machine mounted soil auger to allow holes of a suitable size to be prepared in the ground at the planting site. The use of such an arrangement facilitates rapid planting using the modular planting system of the present invention. The base of the hole can then be appropriately prepared depending on the specific site requirements. For example, the base may undergo sub-grade preparation, drainage or the installation of water retention structures may be provided as required.

The modular planting system may be dropped into the hole such that the top of the planting system is located at least substantially level with the ground level. The root ball of a plant may then be located within the inner volume of the planting system and supported on the inner support. The inner support may be formed of a biodegradable material such that it will decompose over time. Alternatively the inner support may be removed at the time of planting.

The lower areas within the inner volume of the planting system may, before the tree is installed be filled with compacted quality soil and fertilizers. This may for example be done before the tree is installed. Furthermore, a drainage or storm water cell base may be installed through the lower portions of the inner volume. The upper portions of the inner volume may be filled with a good quality friable soil to the required depth, this soil surrounding the root ball of the plant. The irrigation system if provided may then be connected to a supply line.

The modular planting system may be easily lifted because of the presence of the support frame. In particular, the elongated structural supports may provide a suitable lifting point to allow for lifting and transportation of the modular planting system. Once the modular planting system has been installed within the planting site, the elongate structural supports may also be used to support stakes partially inserted into an upper opening of the channel portion of each structural support. It is therefore preferable that the structural supports be of non-biodegradable material. The plant may then be stabilised by means of ties extending between the upwardly extending stakes and the plant itself. Alternatively, in urban situations where plants need to be planted within the pavement of a street for example, a horizontal grille system and/or tree guard system is normally installed around the plant. This grille system and/or tree guard system can also be locked or secured onto the structural supports or support hoop of the support frame as an added security measure.

It is also proposed that the modular planting system be provided as a direct site install system where the system is delivered on site in an unassembled kit, and is then assembled on site.

The modular planting system according to the present invention ensures that the planting conditions of the plant are optimal while at the same time facilitating the planting process.

Terms such as ‘vertical’ and ‘horizontal’ have been used to define features of the present invention. These terms relate to the normal orientation of the modular planting system when in use. It is to be appreciated that the modular planting system may assume alternative orientations, and that the scope of the present invention should not be construed to being limited by these terms.

### BRIEF DESCRIPTION OF THE INVENTION

It will be convenient to further describe the invention with reference to the accompanying drawings which illustrate preferred embodiments of the present invention. Other embodiments are envisaged, and consequently, the particularity of the accompanying drawings is not to be understood as superseding the generality of the preceding description of the invention.

In the drawings:

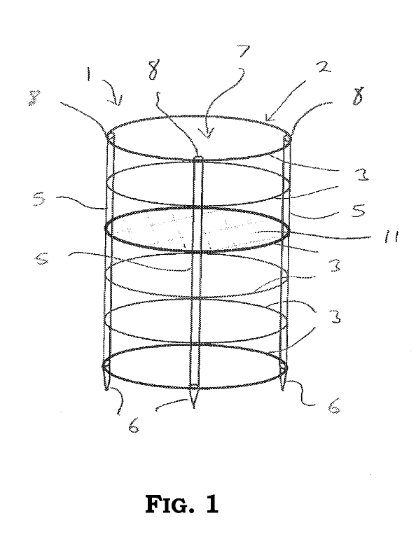

FIG. 1 is a perspective view of a modular planting system according to a first embodiment of the present invention;

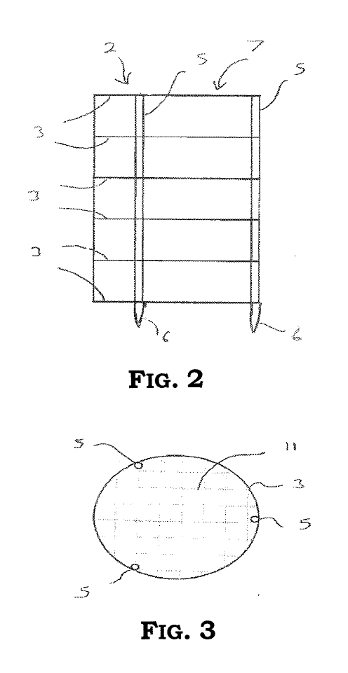

FIG. 2 is a side view of the modular planting system of FIG. 1;

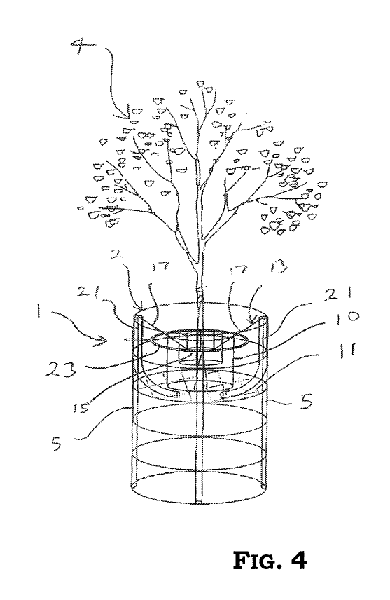

FIG. 3 is a top view of the modular planting system of FIG. 1;

FIG. 4 is a perspective view of the modular planting system of FIG. 1 accommodating a root ball of a tree;

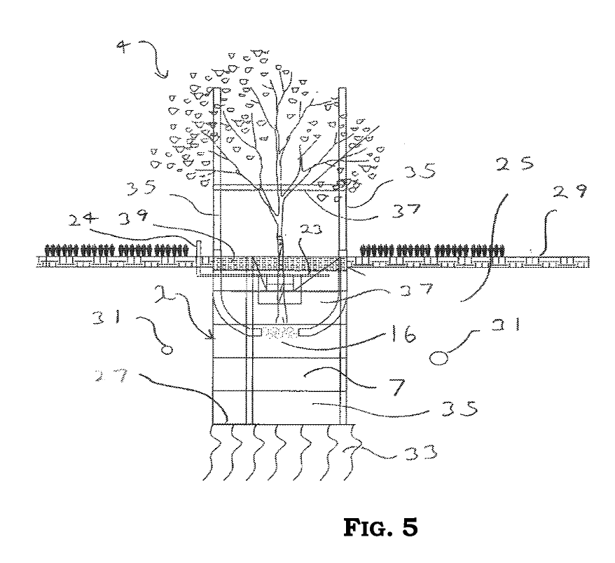

FIG. 5 is a side view of the modular planting system of FIG. 1 shown planted within the ground;

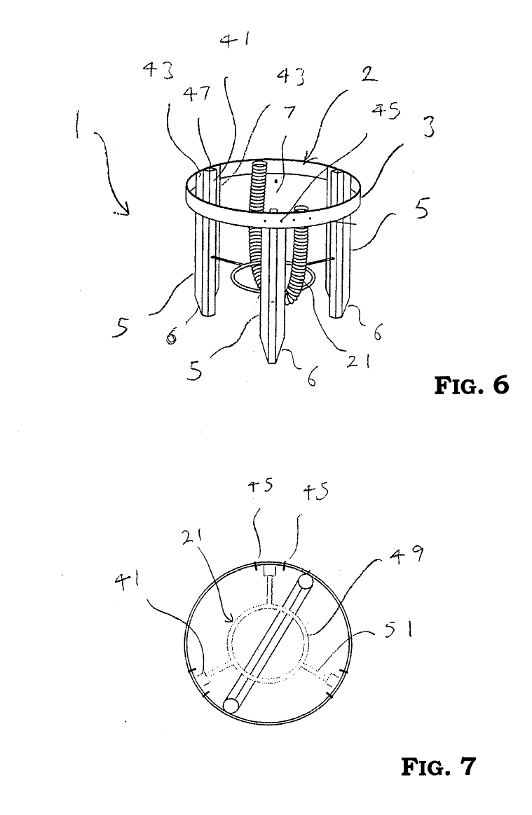

FIG. 6 is a perspective view of a further embodiment of the modular planting system according to the present invention; and

FIG. 7 is a top view of the modular planting system of FIG. 6.

### DETAILED DESCRIPTION OF THE INVENTION

In describing the different embodiments of the modular planting system 1 according to the present invention, the same reference numerals are used to refer to features common to each of the embodiments for clarity reasons.

Referring initially to FIGS. 1 to 3, there is shown a first embodiment of a modular planting system 1 according to the present invention. The modular planting system includes a support frame 2 formed from a number of generally circular rings or hoops 3 spaced in a vertically aligned arrangement. Three vertical elongated structural supports 5 support the circular hoops 3 in this arrangement, with each hoop 3 being secured to each of the three structural supports 5 such that the hoops 3 are positioned generally perpendicular to the elongate extent of each vertical structural support 5. One of the hoops accommodates an inner support 11 in the form of a support platform, the purpose of which will be subsequently described. Each structural support 5 may be in the form of an elongate pipe, and may be equally spaced 120° around the circular hoops 3. One end 6 of each pipe 5 is provided with a spike for securing and levelling the planting system within the ground. The opposing end 8 of each structural support 5 may provide a lifting point for the modular planting system 1. Each of the opposing ends 8 may also allow an end of a stake for supporting the plant to be inserted therein to provide strong support for the stake. Alternatively, in urban applications, a plant grille can be secured to the opposing ends 8 to thereby provide strong anchor points for the grille. Holes can be provided within the pipes 5 to facilitate attachment of the hoops 3, and the support platform 11, by for example cable ties, or wire. An outer mesh material (not shown) can be wrapped around and be supported on the support frame 2 to act as a root guard curtain for the plant. This material may be formed from a number of different proprietary root guard fabrics. At least the circular wire hoops 3 of the support frame 2 may be formed of a biodegradable material such as steel or a biodegradable polymer.

Referring now to FIGS. 4 and 5, the modular planting system 1 encloses a cylindrically shaped inner volume 7 within which a young tree sapling 4 can be at least partially accommodated. The sapling 4 can sit on the support platform 11 provided within the inner volume 7. The support frame 2 further includes a secondary side support 13 for locating the plant at a central location within the inner volume 7. The secondary side support 13 includes a central wire hoop 15 which encircles the plant root ball, and three radially extending wires 17 extending from the central wire hoop to each vertical structural support 5 respectively.

The support platform 11 is located at an adjustable height and may be in the form of a wire grille. The secondary side support 13 is retained in position around the root ball as the plant grows and therefore becomes entwined within that root ball. This arrangement helps to support and stabilise the tree 2 once planted.

Irrigation systems may also be also accommodated within the inner volume 7 at this time. A pair of socked agricultural pipes 21 can be secured within the support frame 2 as shown in FIG. 4, each agricultural pipe 21 can be secured against one of the vertical structural supports 5 and can extend from the top of the support frame 2 before bending under the root ball 10 of the tree 4. Furthermore, a circular irrigation system 23 can be installed around the trunk of the tree 4.

FIG. 5 shows the modular planting system 1 now located within a hole 27 pre-dug within a planting site 25. The hole is dimensioned to fully accommodate the modular planting system 1 such that the top of the system is generally level with the ground 29 at installation. A root guard curtain (not shown) may be pre-wrapped around the support frame 2 to protect any external services 31 such as power or communication lines located within the planting site 25 and near the root guard curtain from any future root incursion by the planted tree 2. A lighter density screen may also be pre-wrapped about the outer mesh near the top thereof to allow air and water to pass.

The hole 27 can be conveniently prepared using a back hoe bucket or a machine mounted soil auger having a diameter substantially the same as the diameter of the modular planting system 1. Following preparation of the base of the hole 27, for example installation of a broken base 33 including sub-grade preparation, drainage and water cells as required. After the modular planting system 1 together with the tree 4 is dropped within the hole 27, the hole is carefully backfilled. The lower portion of the inner volume 7 of the modular planting system 1 may be filled with Australian Standard quality soil or a storm water cell base 35, while the upper portion of the inner volume 7 may be filled with Australian standard soil 37 such that this soil surrounds the root ball of the tree 4. A final mulch layer 39 may then be added to the top of the backfilled soil 37, and the irrigation system 23 connected to a water supply 24. Water storage or other drainage devices 35 may also be located within the inner volume 7.

Finally, a support stake 35 may be inserted into the top of each structural support 5 and a tie 37 provided between the tree and each structural support 5 to provide additional support for the newly planted tree 2.

FIG. 5 shows the modular planting system 1 having a vertical dimension which allows the planting system to be planted such that the planting system extends substantially below the root ball of the plant. It may however not always be necessary for the inner volume of the modular planting system 1 to extend so deep under the plant. The optimum depth required will depend on factors including the application that the modular planting system 1 is being used for, and site factor such as the soil type and the water drainage at the planting site. Therefore, the vertical dimension of the modular planting system can be less than what is shown in FIG. 5 and the plant may be therefore be supported closer to the bottom of the hole dug for supporting the planting system.

FIGS. 6 and 7 show a further embodiment of the modular planting system 1 according to the present invention. This embodiment provides a direct site install system where the various components of the modular planting system 1 can be assembled on site.

As best shown in FIG. 6, the support frame 2 includes three generally vertically aligned structural supports 5. The structural supports 5 are each secured at their upper ends to a support hoop 3. The support hoop 3 can be made of a plastic material such as HDPE. The use of other materials such as stainless steel is also envisaged depending on the application that the modular planting system is being used in. The structural supports 5 may be in the form of a corrugated sheet or a channel section having a central channel portion 41 and peripheral flange portions 43. Corresponding apertures may be provided through the flange portions 43 and through the support hoop 3 to allow fastening means 45 such as plastic rivets or other fastening means to be inserted therethrough to secure the structural supports to the support hoop 3. While the support hoop 3 is shown as being circular in shape, it is also envisaged that the support hoop 3 be square or some other shape as required. The channel portion 41 provides a generally vertically aligned opening 47 through which a plant stake can be inserted. One or more tags (not shown) may extend from the flange portions 43 over the channel portion 41. These tags help to guide the plant stake through the channel portion 41. The bottom end 6 of each structural support 5 are tapered to act as a spike to secure and level the modular planting system 1 within the ground.

The support frame 2 provides a generally cylindrical inner volume 7 within which is supported the inner support 11 for supporting the root ball of a plant within the inner volume 7. As best shown in FIG. 6, the inner support 11 includes an annular ring 49 having radially extending members 51 for respectively engaging a structural support 5. An aperture (not shown) can be provided through each structural support 5 for accommodating the free end of a radially extending member 51.

An agricultural pipe 21 can be installed within the inner volume 7 for irrigation purposes. The ends of the pipe 21 are secured to the support loop 3, for example by a cable tie, with the pipe 21 looping under the inner support 21.

As with the previously described embodiment, fabric material may be wrapped around the support frame 2 to act as a root guard curtain for the plant. Furthermore, the modular planting system 1 shown in FIGS. 6 and 7 can be installed in a similar manner to the previously described embodiment.

While the modular planting system of the present invention has been described in relation to the planting of a single tree, it is also possible to plant more than one plant at one time using the present invention. Furthermore, the modular planting system can be provided both as a pre-assembled unit and as a direct site install system where the modular planting system may be provided as a ‘flat pack’ and may be assembled onsite. The carton within which is accommodated the separate components of the modular planting system may be made of an organic material such as cardboard or paper which could be used to provide the initial mulch layer for the plant once planted.

The modular planting system may also be made in a number of different sizes depending on the plant being planted using the system.

Modifications and variations as would be deemed obvious to the person skilled in the art are included within the ambit of the present invention as claimed in the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (Cancelled)

16. (canceled)

17. (canceled)

18. A modular planting system for at least one plant, the system comprising:
a support frame having an inner volume within which can be located at least one root ball of a plant, wherein the root ball is locatable at an optimal position for growth of the plant when the modular planting system is placed within a hole dug to at least substantially accommodate the modular planting system.

19. The modular planting system of claim 18, wherein the support frame includes a plurality of generally vertically aligned structural supports, and at least one generally horizontally aligned support hoop to which the structural supports are secured.

20. The modular planting system of claim 18, wherein the support frame provides at least one generally vertically aligned opening that allow a plant stake to be accommodated therein.

21. The modular planting system of claim 19, wherein each structural support is in the form of an elongate tube.

22. The modular planting system of claim 19, wherein each structural support is in the form of a corrugated sheet or channel section having a channel portion and one or two peripheral flange portions on one or either side of the channel portion.

23. The modular planting system of claim 18, further comprising an inner support within the inner volume for supporting the root ball therein.

24. The modular planting system of claim 23, wherein the inner support in the form of a substantially annular ring having radially extending members for respectively engaging a said structural support, the annular ring supporting the root ball.

25. The modular planting system of claim 23, wherein the inner support is in the form of a support platform located under the root.

26. The modular planting system of claim 18, wherein at least a root guard curtain is supported around the support frame.

27. The modular planting system of claim 18, further comprising at least one water application device supported therein.

28. The modular planting system of claim 26, wherein the water application device includes one or more socked agricultural pipes secured to the support frame extending from a position adjacent the top of the modular planting system to a position under the root ball thereof.

29. The modular planting system of claim 26, wherein the water application device includes an irrigation system supported on the modular planting system extending above and/or around the root ball thereof.

30. The modular planting system of claim 18, wherein the support frame has a generally cylindrical shape and encloses a generally cylindrical inner volume.

31. The modular planting system of claim 18, wherein the support frame is formed from a plurality of generally circular rings or hoops spaced in a vertically aligned arrangement, and a plurality of vertically aligned elongated structural supports, each circular ring or hoop being secured to one or more of the structural supports.

32. The modular planting system of claim 31, wherein each structural support is in the form of an elongate pipe.

33. The modular planting system of claim 18, wherein at least part of the modular planting system is formed from biodegradable material.

34. The modular planting system of claim 18, wherein the support frame is sized so that the dug hole provides a volume of ground or soil disturbance of at least three times the volume of the root ball.

35. A method of planting one or more plants using a modular planting system having a support frame with an inner volume within which can be located at least one root ball of a plant, wherein the root ball is locatable at an optimal position for growth of the plant when the modular planting system is placed within a hole dug to at least substantially accommodate the modular planting system, the method comprising:
digging a hole at a planting site, the hole having a diameter and depth sufficient to at least substantially accommodate the modular planting system;
dropping the modular planting system into the hole;
planting a root ball of the or each plant within; and
backfilling the inner volume of the modular planting system.
